(19) United States
(12) Patent Application Publication
(10) Pub. No.: US 2014/0118136 A1
(43) Pub. Date: May 1, 2014

(54) ANTI-THEFT ELECTRONIC DEVICE

(71) Applicant: Adrian Florentin State, Mogosoaia (RO)

(72) Inventor: Adrian Florentin State, Mogosoaia (RO)

(21) Appl. No.: 14/126,977

(22) PCT Filed: Jan. 18, 2012
(86) PCT No.: PCT/RO2012/000001

§ 371 Date: Dec. 17, 2013

(30) Foreign Application Priority Data
Jun. 20, 2011 (RO) A 2011 00575

(51) Int. Cl. G08B 13/14

(52) U.S. Cl. CPC G08B 13/1436
USPC 340/539.11

(57) ABSTRACT

The electronic protection device against theft/vandalism allows capturing, processing and treatment of a signal coming outside which is caused by a person other than the owner and user of such device. Thus, as a result of biodetection of a strange person's specific biometric features, it transmits with some specialized modules, through an amplifier, an alarm signal toward some audible/optical devices, GSM phones and visual monitoring. Upon changing the position of the device caused by attempted theft, some GPS capturing and transmission devices 1′, 2′ send amplified signals to another device 3′ which, as its turn, sends a final signal to some alarming GSM phone devices 4′ and monitoring visualization 5′.c.

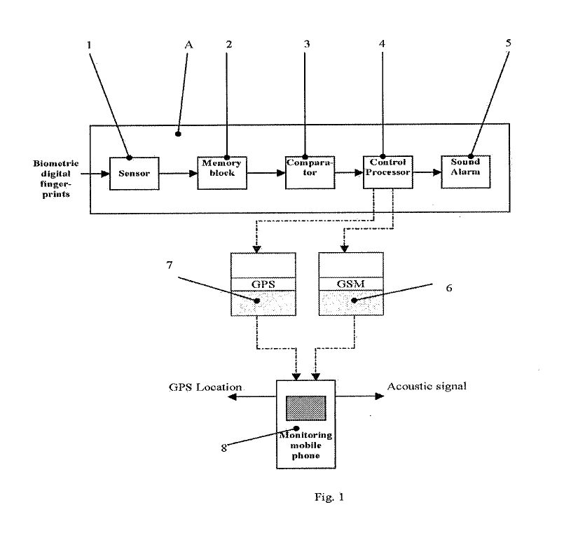

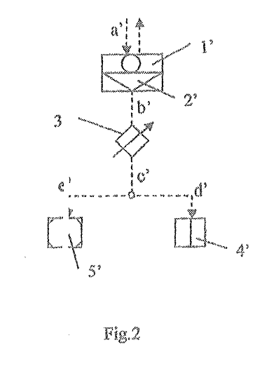

### CROSS REFERENCE TO RELATED APPLICATIONS

This application is the U.S. National Phase Application of PCT/RO2012/000001, filed Jan. 18, 2012, which claims priority to Romanian Patent Application No. a 2011 00575, filed Jun. 20, 2011, the contents of such applications being incorporated by reference herein.

### FIELD OF THE INVENTION

The invention refers to an anti-theft electronic device destined for incorporation into personal objects to be monitored, such as a wallet or a mobile phone, device that ensures a protective function in an attempted theft and/or in the identification of the object or the thief, in case of loss or thievery.

### BACKGROUND OF THE INVENTION

There are known various types of devices, systems and electronic equipment, that may be attached to fixed objects, valuables, or to objects that contain important information, and which transmit alarm signals in case of intervention thereon or even in case of the changing of their position. Said equipment is provided with sensors, memories, analyzer, comparators, amplifiers and transmitters, being connected to fixed stations or servers, for processing the information received and for signaling unauthorized intervention to a supervision and intervention station (see, in this respect, U.S. patent 2008/095409 A1, of Oct. 23, 2006, published on Apr. 24, 2008).

The disadvantages of said equipment consist in the complicated constructional solutions, relatively big, and which involve excessive costs and need for additional installations and for supervision staff. Another disadvantage is given by the fact that said electronic equipment cannot be attached to small objects.

### SUMMARY OF THE INVENTION

The technical problem, which is being solved by the present invention, is the making of an anti-theft electronic device, which allows its attachment to small objects and instantaneous signaling of the movement of the object to which it is attached.

The anti-theft electronic device, according to this invention, solves said technical problem and eliminates said disadvantages, in that it is provided with a single biometric, digital, fingerprints sensor, which serves as an unique interface both for the biometric fingerprints of the owner of the device as well as for the biometric fingerprints of a person who would attempt, possibly, to steal it, with a processor integrated in the device, which receives a signal coming from a fingerprint comparator, signal that, in case of identification of a fingerprint different from the one of the rightful owner, issues an alarm warning signal and, through a mobile telephone system and a geographic positioning system, using distinct pulses, to a mobile phone monitoring the movement of the object that is embedding the anti-theft electronic device.

The anti-theft electronic device, according to the invention, has the following advantages:
it is miniaturized and allows discreet incorporation into a personal object;
substantially reduces the manufacturing costs;
eliminates adjacent installations and the supervision staff;
it alerts, directly, immediately, the owner of the object to which the device is attached, regarding the position of the lost or abusively-appropriated object.

### BRIEF DESCRIPTION OF THE DRAWINGS

An embodiment of the invention is given hereinafter, in connection also with the sole FIGURE which is a block diagram of the anti-theft electronic device.

### DETAILED DESCRIPTION OF THE INVENTION

The anti-theft electronic device, according to the invention, is provided with a human biometric sensor 1, for biometric, digital, fingerprints, connected to a memory block 2, and this to a fingerprint comparator 3. The pulse coming from the comparator 3 reaches a control processor 4 which, in case of identification of a foreign fingerprint, gives the “start” command, for transmission of a warning signal to an alarm 5 and, by means of a mobile telephone system (GSM) 6 and a geographic positioning system (GPS) 7, through distinct pulses, to a mobile phone 8 monitoring the movement of the object that is embedding the device. As it can be understood, the link between an anti-theft device A that comprises the biometric sensor 1, the memory block 2, the comparator 3, the control processor 4 and the alarm 5, combined in a standalone construction, as well as the two communication 6 and positioning 7 systems and, finally, a monitoring mobile phone 8, is made wirelessly (wireless).

The device A, miniaturized in line with the present state of art, can be mounted on an object of personal use, such as, for example, a wallet or a mobile phone. By means of a sensor fitted within its circuit, the sensor 1 can perceive human biometric fingerprints, which are processed and transmitted to the memory block 2, to be stored. The first of them, which will be set as blank fingerprints or comparison models, must be biometric, digital, fingerprints of the owner of the object in which the anti-theft device is incorporated, according to the invention.

As long as the object is handled or touched by its owner only and the comparator 3 detects the same, memorized, digital, biometric fingerprints, the device A is in a state so called standby or sleep mode (“standby”), given that the control processor 4 is not transmitting any pulse. When the mentioned object is touched by another person, the sensor 1, takes on the new biometric fingerprints, transmits them, through the memory block 2, to the comparator 3, which detects the difference between the new fingerprints and the “known” ones, sending further a signal to the control processor 4 that there is a “disturbance”, thus activating the entire assembly.

The activation pulse is transmitted to the sound alarm 5 and, in parallel, by wireless signal (wireless), to the systems 6 and 7, as follows: a warning signal to the communication system GSM 6 and a geographical location signal to the GPS system 7. The signals will be received, on one hand, as an alarm signal, in the device A, incorporated in the personal object, respectively in the speaker of the mobile phone 8 monitoring the movement of the personal object, and on the other hand, as a geographical location signal, which will appear on the screen of the same monitoring phone 8 after the appropriate maneuver of connecting it to the GPS network 7.

In this way, the owner of the wallet or mobile phone, in which the device A is incorporated, will find out immediately, through the alarm 5 of the device and through the alarm of the monitoring mobile phone 8 (alarm which needs to be set separately from that of a normal call) that someone else touched it, and moreover, he/she will see where it is and it may follow its movement, in real time. Having been warned that an unauthorized intervention took place, the owner of the protected wallet or mobile phone will be able to take the necessary legal actions regarding the theft and recovery of the personal object

The anti-theft electronic device, according to the invention, can be used to locate the object on which it is mounted, even when it was lost without noticing or simply left somewhere. For such situations, the device A can be activated by a command from the monitoring mobile phone 8, following to receive, via the GPS system 7, the position of the lost or forgotten object. The owner of the object will be able to identify the place where the object is located.

The device according to the invention can be attached not only to a wallet or a mobile phone, but also to a purse, a briefcase, a laptop, a second mobile phone, belonging to the same person, in general, to any portable object whose value justifies being monitored. The device should be placed, within the protected object, so as to be able to take digital biometric fingerprints during the handling of said object.

1.-2. (canceled)

3. Anti-theft electronic device, destined for incorporation in objects of personal use, for signaling in the event of theft or loss of the respective object, on the basis of the taking of biometric digital fingerprints, comprised of a sensor, for digital fingerprint, connected to a memory block, and this, to a fingerprint comparator, and which uses mobile communication and geographic location systems, as well as an alarm incorporated in the device, and a mobile phone monitoring the movement of the object, wherein it is provided with a single sensor, which serves as an unique interface both for the biometric, digital, fingerprints of the owner of the device, as well as for the biometric, digital, fingerprints of a potential person who may attempt to steal it, with a memory block and with a control processor, integrated in the device, that receives a signal from the fingerprint comparator which, in the case of identification of fingerprints different from those of the rightful owner, issues a warning signal through the alarm also incorporated in the device, and further, by the mobile phone system and the geographic positioning system, through distinct pulses, to the mobile phone monitoring the movement of the personal object.

4. The anti-theft electronic device according to claim 3, wherein all components of the device, namely: the sensor, the memory block, the comparator, the control processor and the alarm are manufactured on a miniaturized scale and are assembled into a compact construction, placed in such way that it can take biometric, digital, fingerprints during the handling of the object in which it is incorporated.
